(19) United States
(12) Patent Application Publication
(10) Pub. No.: US 2026/0015898 A1
(43) Pub. Date: Jan. 15, 2026

(54) LATCH AND STRIKER SYSTEM AND OPENING AND CLOSING DEVICE INCLUDING SUCH A SYSTEM

(71) Applicant: THIRIET, WARCQ (FR)

(72) Inventors: Emeric BENARD, WARCQ (FR); Ludovic BOSSEAUX, WARCQ (FR); Romain GARCIA-NOTARIO, WARCQ (FR); Joël RIBEIRO, WARCQ (FR); Philippe THIRIET, WARCQ (FR)

(73) Assignee: THIRIET, WARCQ (FR)

(21) Appl. No.: 19/263,617

(22) Filed: Jul. 9, 2025

(30) Foreign Application Priority Data
Jul. 12, 2024 (FR) 2407636

(51) Int. Cl. E05B 85/24; E05B 79/12; E05B 83/42; E05B 85/04

(52) U.S. Cl. CPC E05B 85/24; E05B 79/12; E05B 83/42; E05B 85/04

(57) ABSTRACT

A latch and striker system for an opening and closing device of a body door of a truck or semitrailer, the system includes a latch (P) and a striker (G), the door being configured to move from an open position to a closed position, by hinging of the door, the opening and closing device configured to move from a locked state for which the latch comes to the engaging and locking position in the striker (G) to an unlocked state (EDV), by pivoting of the control bar, allowing a gap between the latch and the striker of an extraction distance (DE) of more than 75 mm.

### FIELD

The present disclosure relates to a latch and striker system for a device for closing and opening a truck or semitrailer door, as well as a closing and opening device including such a system.

The latch and striker system, and the closing and opening device, are particularly suitable for locking doors fitted with elastomer seals, in particular large ones, which provide a seal between the frame and the door or doors, and such as can be found in the bodies of refrigerated trucks or semitrailers.

The present disclosure falls within the field of closing and opening devices for a truck or semitrailer, commonly referred to as “door lock bars” by those skilled in the art.

### BACKGROUND

A device is known, in particular from document FR2906828 of the present Applicant, for opening and closing a truck or semitrailer door.

Doors of trucks or semitrailers, generally comprise two hinged doors, right and left, respectively hinged by hinges with two frame posts, and along two substantially vertical pivot axes.

Each door comprises an opening and closing device which comprises a control bar, pivoted, on the outer side of the door, by bearings, as well as an actuating member, typically including a actuating lever constrained to rotate with the control bar, and which makes it possible to rotate the control bar, following an angular travel of the order of a quarter of a turn, or even more, to unlock or lock the door. The actuating member is further configured to ensure locking, by blocking the actuating member with respect to rotation, in a closed position of the device.

The opening and closing device further includes latch and striker systems, forming upper and lower locks to the door, typically for each door:
an upper lock including an upper striker, secured to an upper cross member of the frame, the striker configured to engage in a locked state with an upper latch secured to the upper end of the control bar,
a lower lock including a lower striker, integral with a lower cross member, the striker configured to engage in a locked state with a lower latch of the lower end of the control bar.

Starting from the unlocked state in which the lower and upper latches are engaged and locked in the respective strikers, an operator opens the door by grasping said actuating member, unlocking its rotation, then causing the bar to rotate so that the latches are simultaneously extracted from the strikers.

Documents U.S. Pat. Nos. 3,549,185 A, 4,235,463 A and EP0270839 A1 show various embodiments of locks including a latch and striker system comprising the aforementioned operation.

According to the findings of the Applicant, and in particular for refrigerated semitrailer doors, even in the unlocked state in which the latches are extracted out of the strikers, opening by the operator still requires pulling on the door in order to release the seals between the frame and the door leaf.

This pulling operation can be cumbersome for the operator, in particular when there are elastomeric seals of large dimensions in thickness, above 70 mm depending on the thickness, such as for example 80 mm or even 90 mm, which offer good sealing performances, but generate significant friction between the leaf and the frame when the door is opened.

In the case of such large seals, once the latches and strikers are unlocked, the operator must still pull hard on the door so that the edges of the door are free from friction and the are released from the seals.

### SUMMARY

The present disclosure improves the situation.

A latch and striker system is proposed for a device for opening and closing a truck or semitrailer body door, the system comprising a latch and a striker, said door being configured to go from an open position to a closed position, by hinging of the door, typically according to a vertical pivoting on a post of a frame, the striker intended to be attached to the frame of the door, typically to an upper cross member or to a lower cross member of the door frame, and the latch intended to be mounted secured at one end to a bar controlling the opening and closing device, said control bar being tubular, pivotably mounted on the door, by means of bearings, said opening and closing device configured to switch from a locked state for which the latch comes into a position of engagement and locking in the striker to an unlocked state, by pivoting of the control bar, allowing escape between the latch and the striker
the latch comprising:
   a male part configured to be nested in a recess of the control bar, at a mouth of the control bar, said male part extending along an axis A, intended to be coaxial with the control bar,
   an engagement part configured to engage and lock in position in said striker extending lengthwise along an axis B, transverse to the axis A, from a proximal end integral with the male part at which at least one locking cavity is provided and up to a distal end including at least one hooking portion,
the striker comprising a body extending in length including, on one side, a flat fastening surface, configured to bear on the door frame, and including on a second side in relief, offset over the length of the striker:
   a hooking member, configured to be hooked by the distal end of the engagement portion of the latch,
   at least one locking protrusion configured to penetrate said at least one locking cavity.

Said latch is configured, during a pivoting to locking about the axis A, from the unlocked state, to successively ensure engagement of the hooking member by said at least one hooking portion and then a traction on the striker until said at least one locking protrusion engages in said at least one cavity in said locked state.

In the locked state, the latch engagement portion extends along the axis B, substantially parallel to the longitudinal axis of the striker, said at least one latch engagement portion hooked onto said hooking member in order to ensure locking of the latch with respect to the striker along the axis B, said at least one locking protrusion engaging in said at least one cavity of the latch so as to ensure locking of the latch with respect to the striker along the axis A of the latch.

The latch and striker system is configured, during a pivoting to unlocking of the latch about the axis A from the locked state to the unlocked state, to successively cause, during the pivoting to unlocking of the latch about the axis A:
a disengagement between said at least one hooking portion of the distal end of the latch and of the hooking member of the striker,
a making contact at the distal end of the latch and at least one guide surface of the striker extending over the body of the striker, lengthwise over the striker body, from a base of the hooking member, and in the direction of said at least one locking protrusion,
a pushing of the latch onto the striker by the distal end of the latch sliding on the guide surface, and until the axis B of the engagement portion of the latch is substantially perpendicular to the fastening surface in an extraction position of the latch.

According to the present disclosure, the extraction distance separating the axis A and the fastening surface of the striker in said extraction position, at the end of pushing, is greater than or equal to 75 mm, preferably greater than 80 mm, for example between 80 mm and 110 mm, such as 87 mm or 97 mm.

The features set out in the following paragraphs can optionally be implemented independently of one another or in combination with one another:
In the locked state for which the latch is engaged in the striker, the locking distance separating the axis A and the fastening surface may be between 20 mm and 32 mm, such as 26.5 mm.
The latch and striker system may be configured, during pivoting to unlocking of the control bar, from the locked state to the unlocked state in the latch extraction position, to move the axis A of the latch away from the fastening surface by a travel projected along a direction perpendicular to the fastening surface greater than 50 mm, preferably greater than 55 mm, such as 60.5 mm, or even greater than 65 mm or 70.5 mm.
The guide surface along which the distal end of the engagement portion of the latch slides during the pivoting to unlocking forms a ramp with respect to the fastening surface, increasing along the direction of the hooking member towards said at least protrusion, and wherein the distal end is configured to run upward along the ramp during the pivoting to unlocking.
A top of the ramp of the guide surface at which the distal end is able to bear on said extraction position, possibly at a distance from the fastening surface (between 15 mm and 23 mm, such as 19 mm), and wherein the height of the ramp along the direction perpendicular to the fastening surface (43) is between 6 mm and 15 mm.
The top of the ramp can form a male protrusion received in a female portion of the latch in the locked state.
The distance separating the axis A from the distal end of the engagement portion of the latch is between 54.5 mm and 90 mm, such as 68 mm or 78 mm.
Said distal end may comprise a fork, and said at least one hooking portion may comprise a first hooking portion and a second hooking portion, spaced apart from each other along the axis A, respectively arranged at the ends of a first leg and of a second leg of the fork,
   and wherein said hooking member is a T-shaped part comprising a vertical wing of the T-shaped part, extending along a direction perpendicular to a fastening surface plane and a horizontal wing of the T-shaped part, said vertical wing protruding from the body of the striker and said horizontal wing oriented along a direction transverse to the longitudinal axis of the striker
   and wherein upon a transition from the unlocked state to the lot state, the first branch and the second branch of the fork are configured to come on either side of the vertical wing of the T-shaped part, the first hooking portion and the second hooking portion configured to hook an inner edge of the horizontal wing of the T-shaped part, on either side of the vertical wing of the T-shaped part.
The guide surface may comprise a first guide surface, and a second guide surface extending parallel along the length of the body of the striker, on either side of said vertical wing of the T-shaped part, and wherein
the first guide surface is configured to cooperate in sliding with the terminal end of the first fork leg, and
the second guide surface is configured to cooperate in sliding with the terminal end of the second fork leg.
Said at least one cavity may comprise a through cavity with a closed contour, arranged intermediate on the engagement portion, between the axis A and said at least one hooking portion, and wherein the striker comprises a protrusion (configured to engage the through cavity in the locked state, said protrusion having:
a first guide slope, configured to engage with a first lateral edge of the through cavity to push back the latch with respect to the striker in a first direction along the direction of the axis A,
a second guide slope, diametrically opposite with respect to the longitudinal axis of the striker, configured to engage with a second lateral edge of the through cavity to push the latch with respect to the striker in a first direction along the direction of the axis A.
The system may comprise a reinforcement rib extending along the direction of the longitudinal axis of the striker between the base of the vertical wing of the T and a base of said protrusion and wherein the engagement portion of the latch comprises a groove, extending along the axis B of the engagement portion 3, housing the reinforcement rib in the locked state.
Said at least one cavity may comprise a V-profile end cavity, opening at the proximal end, on the side of the axis A opposite the distal end of the latch engagement portion, and wherein the striker comprises a triangular protrusion comprising two V-shaped abutment surfaces consisting of a first abutment surface and a second abutment surface configured to cooperate with the two walls of the V-shaped cavity.

According to one embodiment, said system can comprise:
said through cavity arranged intermediate on the engagement portion, between the axis A and said at least one hooking portion forming a first cavity, configured to engage with the protrusion which is a first protrusion
said end cavity opening at the proximal end, on the side of the axis A opposite the distal end of the engagement portion of the latch forming a second cavity configured to engage with the triangular protrusion which is a second protrusion
   and wherein, in the locked state, the latch is locked relative to the striker, by the first protrusion in the first cavity and by the second protrusion in the second cavity, on either side of the axis A.

The first protrusion and the second protrusion are configured, when the latch is pivoted to locking about the axis A, from the unlocked state to the locked state, to ensure:
a first centring of the latch with respect to the striker along the direction of the axis A by working the first guide slope on the first lateral edge of the through cavity and/or the second guide slope on the second lateral edge of the through cavity, then successively
a second centring of the latch with respect to the striker along the direction of the axis A by working one of the first of the two V-shaped walls of the triangular protrusion on one of the two V-shaped walls of the second cavity and/or working a second of the two V-shaped walls of the triangular protrusion on the other of the two V-shaped walls of the second cavity.

According to one embodiment, said proximal end of the engagement portion can include a cylindrical portion coaxial to the axis A, and wherein, in the locked state, the striker comprises a semi-cylindrical cavity, partially receiving the cylindrical portion, in particular the semi-cylindrical cavity arranged between the first protrusion and the second protrusion.

According to one embodiment, the ramp of the guide surface, increasing along the direction of the hooking member, relative to the fastening surface, towards said at least protruding surface, extends up to a top formed by a plate, substantially parallel to the fastening surface (of said striker, a plate on which the distal end of the engagement portion abuts in said unlocked state. The plate can extend along the length of the striker between the first protrusion (41) and the second protrusion.

According to one embodiment, said proximal end of said engagement portion of the latch can comprise a tapered portion with a thickness Ep2, less than the thickness Ep1 of a median portion of the engagement portion between said distal end and said proximal end, the tapered portion configured to come opposite the plate in the locked state.

According to one embodiment, the latch and the striker are forged metal parts.

According to one embodiment:
the latch includes a plane of symmetry passing through the axis A of the male part, and through the axis B, longitudinal to the engagement part,
the striker includes a plane of symmetry passing through the longitudinal axis of said striker.

According to a second aspect, the device for opening and closing a truck or semitrailer door, comprising at least one hinged door pivoted to a post of a frame, the device comprising a control bar pivoted by bearings at the door, as well as at least one latch and retainer system according to the present disclosure, the latch of which is attached to an end of the control bar, and the striker attached by the fastening surface to a cross member, top or bottom, of the door frame

and wherein the latch and striker system is configured, during a pivoting to unlocking of the latch about the axis A from the locked state to said unlocked state, to successively cause, during the pivoting to unlocking of the latch about the axis A:
a disengagement between said at least one hooking portion of the distal end of the latch and of the hooking member of the striker,
a making contact between the distal end of the latch and at least one guide surface of the striker extending on the body of the striker, lengthwise on the striker body, from a base of the hooking member, and in the direction of said at least one locking protrusion,
a pushing of the latch on the striker by the distal end of the latch sliding on the guide surface, and until the axis B of the engagement portion of the latch is substantially perpendicular to the fastening surface in an extraction position, and wherein the extraction distance separating the axis A and the fastening surface of the striker in said extraction position, at the end of the push, is greater than or equal to 75 mm, preferably greater than 80 mm, for example between 80 mm and 110 mm, such as 87 mm or 97 mm, and preferably according to a movement of the axis A by a travel projected along a direction perpendicular to the fastening surface greater than 50 mm, preferably greater than 55 mm, such as 60.5 mm, or even greater than 65 mm, such as 70.5 mm. The present disclosure further relates to the use of the opening and closing device according to the present disclosure for a refrigerated semitrailer or refrigerated truck door comprising seals between the frame and the door, said latch extraction position configured to ensure a movement of the door upon opening at the axis A, allowing a disengagement of the seals.

### BRIEF DESCRIPTION OF THE DRAWINGS

Other features, details and advantages will appear upon reading the detailed description hereinafter, and on analysis of the appended drawings, wherein:

FIG. 1 is a perspective view of a latch and striker system according to the present disclosure, according to a first embodiment, in the locked state for which the latch is engaged and locked in the striker, the latch including a male portion extending along an axis A, configured to be nested and secured typically by welding to a control bar, and an engagement portion extending along an axis B.

FIG. 2 is a view of the system in the locked state according to FIG. 1, viewed along the axis A.

FIG. 3 is a view of the system in the locked state according to FIG. 1, front view.

FIG. 4 is a successive view of FIG. 2 when the latch initiates pivoting to unlocking, causing the distal end of the latch to disengage from the hooking member of the striker, and then the distal end to abut against a guide surface of the latch, at the base of the hooking member.

FIG. 5 is a successive view of FIG. 4 during pivoting to unlocking, the distal end of the latch sliding on the guide surface continuing the pushing and separation from the axis A.

FIG. 6 is a successive view of FIG. 5 during pivoting upon unlocking, the distal end of the latch sliding on a rising ramp of the guide surface continuing the pushing and separation from the axis A

FIG. 7 is a successive view of FIG. 6 during pivoting to unlocking, the distal end of the latch in contact at the top of the rising ramp of the guide surface illustrating the extraction position for which the axis B of the latch is perpendicular to the fastening surface of the striker, i.e. the position for which the axis A is furthest away from the fastening surface of the striker during pivoting to unlocking.

FIG. 8 is a view of the latch and striker system during a pivoting to locking of the latch, before hooking of the distal end of the latch with the T-shaped hooking member of the striker.

FIG. 9 is a front view of the latch illustrating in particular the distal end of the latch, which includes a fork, with a first branch terminating in a first hooking portion and a second branch terminating in a second hooking portion, illustrating in particular the entry of the fork, including opposite guide surfaces between the two fork arms, converging in the direction of insertion, with a centring function, the converging guide surfaces, followed respectively by rectilinear guide surfaces between which the vertical wing of the T-shaped part of the hooking member is housed, in said locked state.

FIG. 10 is a sectional view passing through the protrusion which is housed in the first cavity, during closing, FIG. 10 being successive to FIG. 9, the distal end of the latch having hooked the striker hooking member, the first protrusion of the striker having a first guide slope configured to ensure a (first) centring of the latch with respect to the striker along the direction of the axis A along a first direction, and a second guide slope configured to ensure a (first) centring of the latch with respect to the striker along the direction of the axis A along a second direction, opposite to the first direction.

FIG. 11 is a successive view of FIG. 10, in order to lock wherein the second guide protrusion, triangular, and the second cavity ensure a second centring, in a first direction according to the direction of the axis A by a first pair of facing walls belonging respectively to the second triangular protrusion and to the V-shaped cavity, or in a second direction in to the direction of the axis A by a second pair of facing walls belonging respectively to the second triangular protrusion and to the V-shaped cavity.

FIG. 12 is a schematic rear view of a semi-trailer body, which includes a loading opening closed by two hinged doors, right and left, respectively mounted by hinges (not illustrated) on two posts of the door frame, each of the doors including an opening and closing device comprising, for each door (right or left):
a control bar, mounted pivoting on the door by bearings, on a pivot axis parallel to the vertical axis of the door hinges, including a control handle for rotating it,
a lower latch and striker system, comprising a striker mounted on the lower cross member of the frame, and a latch mounted so as to be constrained to rotate with the lower end of the control bar, and,
an upper latch and striker system, comprising a striker mounted on the upper cross member of the frame, and a latch mounted so as to be constrained to rotate with the upper end of the control bar.

FIG. 13 is a perspective view of a latch and striker system according to the present disclosure, according to a second embodiment, in the locked state for which the latch is engaged and locked in the striker, the latch including a male portion extending along an axis A, configured to be nested and attached to a control bar, and an engagement portion extending along an axis B.

FIG. 14 is a view of the system according to FIG. 13 in the locked state, viewed along the axis A.

FIG. 15 is a perspective view of the system according to FIG. 13 in the unlocked state

FIG. 16 is a perspective view of the system according to FIG. 13 in the unlocked state

### DETAILED DESCRIPTION

The present disclosure relates to a latch and striker system for an opening and closing device 1 of a truck or semitrailer door, the system comprising a latch P and a striker G, said door PT being configured to move from an open position to a closed position, by hinging of the door PT, typically on to a vertical pivot on a post M of a frame DM, the striker intended to be attached to the frame DM of the door, typically to an upper cross member TS or to a lower cross member TI of the door frame, and the latch intended to be mounted secured to an end of a control bar BC of the tubular opening and closing device. The control bar is pivotably mounted on the door, typically via bearings PL.

The opening and closing device 1 is configured to switch from a locked state EV for which the latch P (lower or upper) comes into the engagement and locking position in the striker to an unlocked state EDV, by pivoting the control bar, allowing disengagement between the latch and the striker.

In general, and as illustrated in FIG. 12, the semitrailer body or a truck body includes a rear opening delimited by a door frame which includes a frame comprising two vertical posts M, and two cross members, including an upper cross member TS and a lower cross member TI.

Two hinged doors are configured to close the opening, the left door, closing the left half of the opening, hinged by hinges on the left frame post while the right door closing the right half of the opening, hinged by hinges on the right frame post.

Each of the doors is equipped with the closing and opening device which includes the control bar BC, extending over the height of the door, hinged on the outer surface of the door by the bearings, and operable by an actuating member constrained to rotate with the control bar, and typically folding in a locking position against the door.

The lower and upper latches are thus constrained to rotate with the control bar, and are configured to engage for locking respectively in strikers G, lower and upper, respectively of the upper cross member TS and of the lower cross member TI of the frame.

Also and generally, said opening and closing device 1 is configured to switch from the locked state EV for which the latch P comes into the engagement and locking position in the striker to an unlocked state EDV, by pivoting the control bar, allowing disengagement between the latch and the striker.

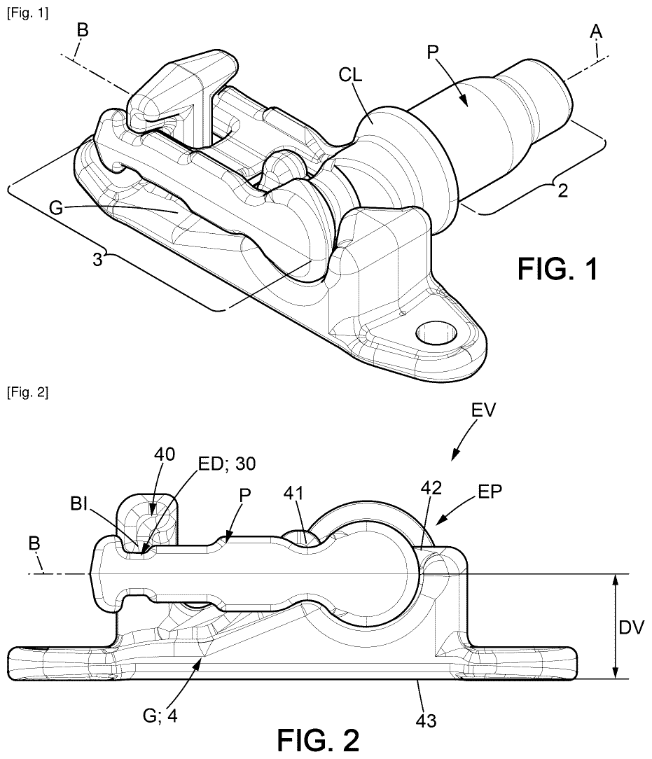

In general and as illustrated in FIG. 1, the (or each) latch P comprises:
a male part 2 configured to be nested in the recess of the control bar BC, at a mouth of the control bar, said male part extending along an axis A, intended to be coaxial to the control bar,
an engagement portion 3 configured to engage and lock in position in said striker, said engagement portion 3 extending in length along an axis B, transverse to the axis A, from a proximal end EP integral with the male portion at which at least one locking cavity Cav 1, Cav 2 is provided and up to a distal end ED including at least one hooking portion 30.

The male part 2 may be substantially cylindrical, or even slightly conical, to be inserted into engagement at the tubular end of the control bar.

The male part 2 may be followed by a collar CL forming a stop for the edge of the control bar. The connection between the control bar and the latch can be ensured by welding, for example between the collar and the control bar, and/or by mounting a ring gripping the tubular portion of the control bar around the male part 2.

The engagement portion 3 extends transversely along the axis B which is perpendicular to the axis A from said proximal end EP, close to the axis A, to the distal end EP further from the axis A.

The engagement portion 3 and the male portion 2 may form an L.

The latch P, including the male part 2 and the engagement part 3, may be a one-piece metal component. The latch is preferably forged, in order to reinforce its strength.

In general, and as illustrated in particular in the figures, the striker G comprises a body 4 extending in length including, on a first side, a fastening surface 43, flat, configured to bear against the door frame, in particular against a vertical surface of the upper cross member TS or the lower cross member TI, and including, on the second side, raised and offset along the length of the striker:
a hooking member 40, configured to be engaged by the distal end EP of the engagement portion 3 of the latch,
at least one locking protrusion 41, 42 configured to penetrate said at least one locking cavity Cav 1, Cav2.

The striker may further include mounting holes OM, in particular at both longitudinal ends of the body, configured for passing fastening members, such as the fastening bolts securing the striker to the frame.

The body 4 of the striker G can be a single-piece metal component. The striker is preferably forged, in order to reinforce its strength. However, other manufacturing methods are possible, for example:
manufacture by foundry,
additive manufacturing, such as 3D printing, or even
manufacturing by material removal, such as machining.

In general:
the latch may include a plane of symmetry passing through the axis A of the male part 2, and the axis B, longitudinal to the engagement part 3, and/or
the striker may include a plane of symmetry passing through the longitudinal axis of said striker.

The latch plane of symmetry allows a single latch reference to be used, which can serve as either the upper or lower latch and regardless of the door opening direction (right or left).

The plane of symmetry of the striker allows a single striker reference to be used, which can serve as either the upper or lower striker, regardless of the door opening direction, right or left.

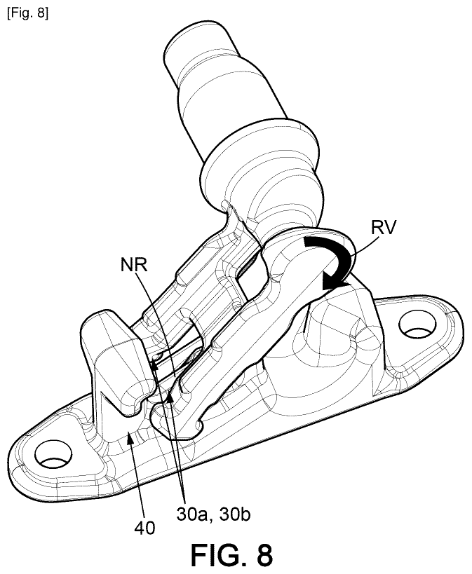

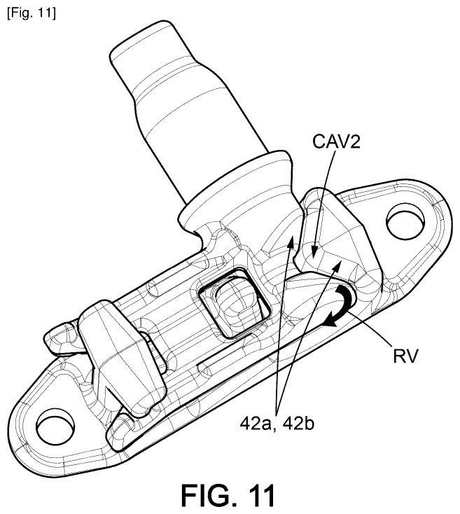

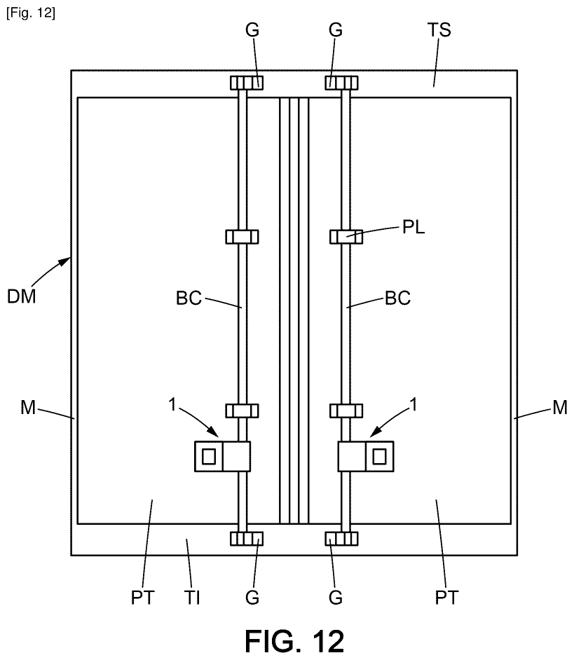

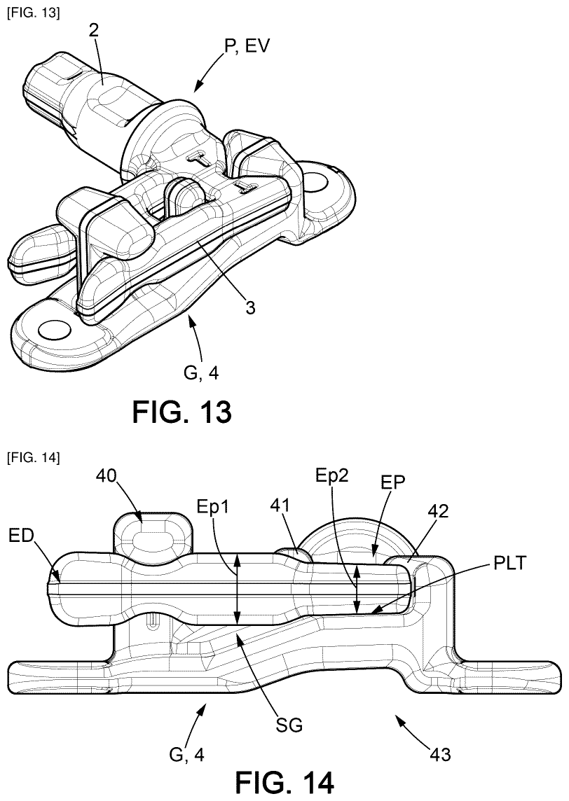

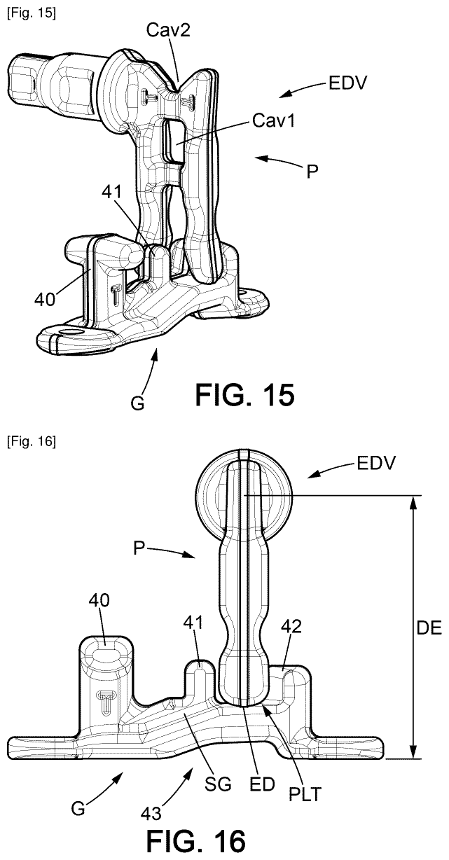

Generally, and as illustrated in FIGS. 8, 9 and 11, said latch P is configured during a pivoting to locking RV about the axis A, from the unlocked state EDV to successively ensure engagement of the hooking member 40 of the striker by said at least one hooking portion 30, and subsequently a traction on the striker until said at least one locking projection 41, 42 engages in said at least one cavity Cav1, Cav2 in said locked state EV.

In the locked state EV, in particular illustrated in FIGS. 1 and 2, the engagement portion of the latch P extends along the axis B, substantially parallel to the longitudinal axis of said striker G, said at least one hooking portion 30 of the latch hooked into said hooking member 40 in order to ensure locking of the latch with respect to the striker along the axis B, said at least one locking protrusion 41, 42 engaging in said at least one cavity of the latch Cav1, Cav2 so as to ensure locking of the latch P with respect to the striker GT along the axis A of the latch.

In general, the latch and striker system is configured during a pivoting to unlocking RD of the latch about the axis A as far as said unlocked state EDV, successively comprising, during the pivoting tour unlocking RD of the latch about the axis A:
a disengagement between said at least one hooking portion 30 of the distal end of the latch and the hooking member 40 of the striker,
a making contact at the distal end ED of the latch and at least one guide surface SG of the striker extending over the body 4 of the striker, lengthwise over the striker body, from a base of the hooking member 30, and in the direction of said at least one locking protrusion 41, 42,
a pushing of the latch P onto the striker by the distal end of the latch sliding on the guide surface, and until the axis B of the engagement portion 3 of the latch is substantially perpendicular to the fastening surface 43 in an extraction position of the latch.

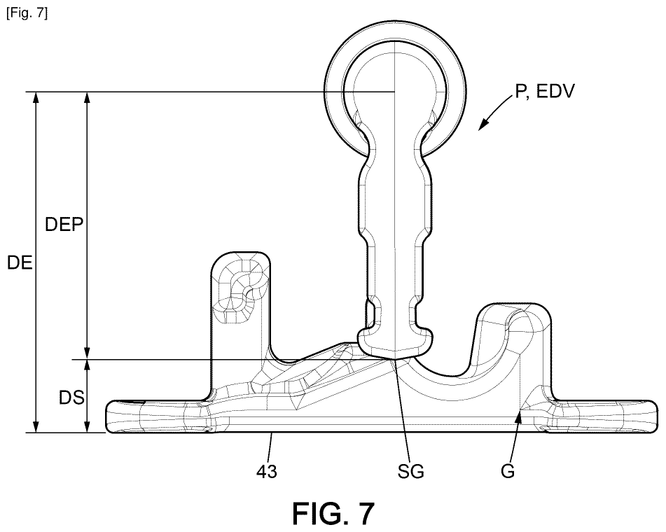

According to the present disclosure, the extraction distance DE separating the axis A and the fastening surface 43 of the striker in said extraction position, at the end of pushing, is greater than or equal to 75 mm, preferably greater than 80 mm, for example between 80 mm and 115 mm, such as 87 mm, in particular according to the embodiment in FIG. 7, or 97 mm according to the embodiment in FIG. 16.

The extraction distance DE greater than or equal to 75 mm is greater than the known art of the Applicant and ensures better detachment of the door. This makes it possible in particular for the door extracted by the action of pushing the latch P on the striker G to release the seals, totally or at least to a large extent, greatly facilitating the opening of the door including seals, in particular wide seals, for example greater than 80 mm according to the thickness direction of the door, such as for example 90 mm.

According to one embodiment, and in the locked state EV for which the latch P is engaged in the striker G, the locking distance separating the axis A and the fastening surface 43 may be between 20 mm and 32 mm, such as 26.5 mm.

Preferably, the latch and striker system is configured, during pivoting to unlocking of the control bar, from the locked state EV to the unlocked state EDV in the extraction position of the latch, to move the axis A of the latch away from the fastening surface 43 by a travel projected along a direction perpendicular to the fastening surface 43 greater than 45 mm, in particular 50 mm, and in particular preferably a projected travel greater than 55 mm, such as 60.5 mm for the first mode of FIG. 7, or even greater than 65 mm, such as 70.5 mm for the second mode of FIG. 16. Such a movement travel is compatible in order to ensure disengagement of the seals and to substantially reduce the friction opposing the opening of the door.

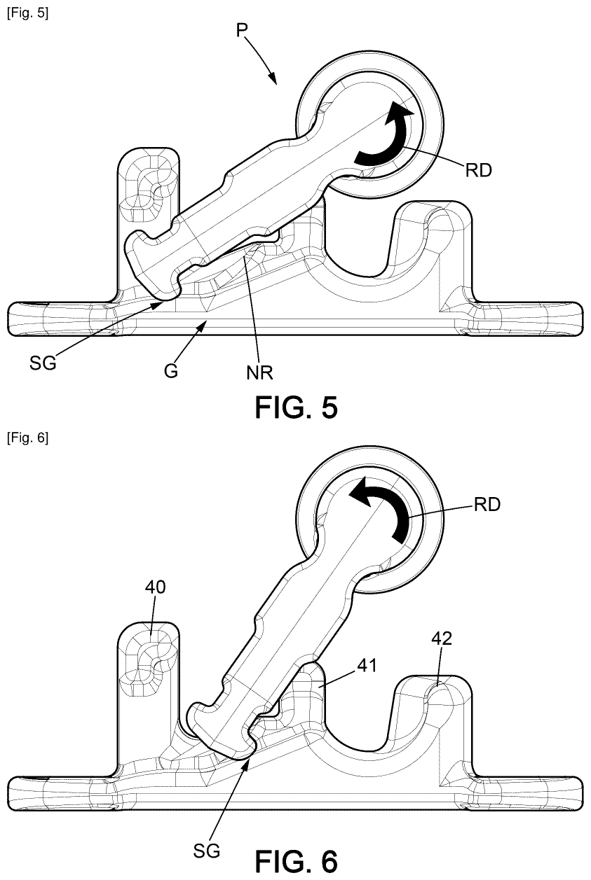

According to one embodiment, the guide surface GD along which the distal end EP of the engagement portion P of the latch slides, during pivoting to unlocking RD, can form a ramp relative to the fastening surface 43, increasing along the direction of the hooking member towards said at least protrusion 41, 42, the distal end ED configured to run upward along the ramp during pivoting to unlocking RD, and as illustrated in FIGS. 5 to 7. The rising profile of the ramp, which is followed by the distal end during pivoting to unlocking RD, allows for amplified extraction.

Thus said movement travel of the axis A, from the locked state to the unlocked state, projected along the direction perpendicular to the axis A, is due in part in itself to the rotation of the latch, as well as to the action of the ramp which tends to move the axis A away during the rotation of the latch.

According to one embodiment, the top of the ramp of the guide surface SG at which the distal end is able to bear on said extraction position, is at a distance DS from the fastening surface 43 of between 15 mm and 23 mm, such as 19 mm. The height of the ramp along the direction perpendicular to the fastening surface 43 may be between 8 mm and 15 mm, such as 12 mm.

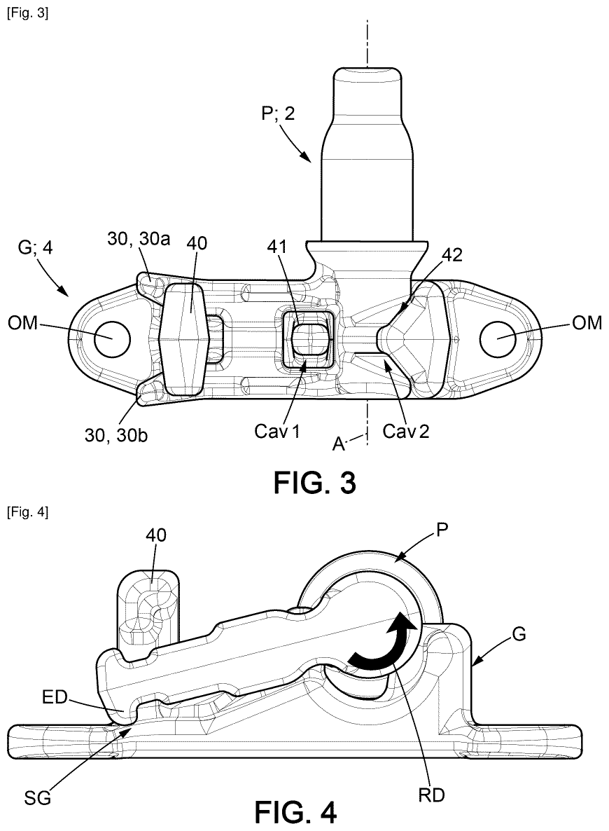

In general, and as can be seen by way of indication in FIG. 3, FIG. 15, the top of the ramp can form a male protrusion received in a female part of the latch in the locked state EV.

In general, the distance DEP separating the axis A from the distal end ED of the engagement portion of the latch is between 54.5 mm and 90 mm, such as 68 mm, according to the first illustrated embodiment, or 78 mm for the second illustrated embodiment.

In general, it should be noted that the extraction distance DE separating the axis A and the fastening surface 43 is the sum of the distance DS separating the top of the ramp of said extraction surface and the distance DEP separating the axis A and the distal end ED, and as illustrated in FIG. 7.

For example, by way of non-limiting example, and in particular according to the first embodiment in FIGS. 1 to 11, the distances may be:
the distance DS is equal to 19 mm,
the distance DEP is equal to 68 mm,
the extraction distance DE is equal to 87 mm.

For example, by way of non-limiting example, and in particular according to the second embodiment in FIGS. 13 to 17, the distances may be:
the distance DS is equal to 19 mm,
the distance DEP is equal to 78 mm,
the extraction distance DE is equal to 97 mm.

According to one embodiment, said distal end ED of the latch P comprises a fork, and said at least one hooking portion 30 comprises a first hooking portion 30a and a second hooking portion 30b, spaced apart from each other along the axis A, respectively arranged at the ends of a first leg and of a second leg of the fork.

Said hooking member 40 of the striker is a T-shaped part comprising a vertical wing of the T-shaped part, extending along a direction perpendicular to a fastening surface plane 43 and a horizontal wing of the T-shaped part, said vertical wing protruding from the body 4 of the striker and said horizontal wing oriented along a direction transverse to the longitudinal axis of the striker.

When switching from the unlocked state EDV to the locked state EV, the first branch BR1 and the second branch BR3 of the fork are configured to come on either side of the vertical wing of the T-shaped part, and as illustrated by way of indication in FIG. 8, the first hooking portion 30a and the second hooking portion 30b being configured to hook simultaneously a lower edge BI of the horizontal wing of the T-shaped part, on either side of the vertical flange of the T-shaped part.

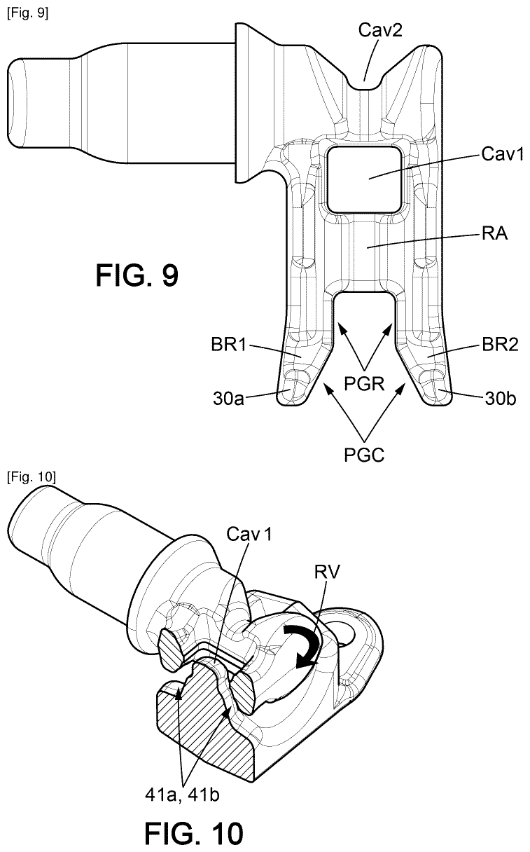

In general, and as illustrated in FIG. 9; the fork may have, from the terminal ends of the branches BR1, BR2, convergent guide walls PGC ensuring a centring of the latch with respect to the striker along the direction of the axis A, by cooperation with the vertical wing of the hooking member 30 when the two branches BR1 and BR2 are inserted on either side of the vertical wing. The convergent guide walls PGC of the two branches BR1, BR2 can be extended in the direction of the axis A of the latch by straight guide walls PGR, parallel to them, ensuring guidance of said vertical wing of the hooking member 30 in the locked state EV.

The guide surface SG can then comprise a first guide surface, and a second guide surface extending parallel along the length of the body of the striker, on either side of said vertical wing of the T-shaped part:
the first guide surface is configured to cooperate slidingly with the terminal end of the first branch BR1 of the fork, and
the second guide surface is configured to cooperate slidingly with the terminal end of the second branch BR2 of the fork.

The first guide surface and the second guide surface extend in parallel over the length of the striker to form said ramp.

According to one embodiment, said at least one cavity Cav 1, Cav 2 comprises a through cavity Cav 1, preferably of closed contour, arranged intermediately on the engagement portion, between the axis A and said at least one hooking portion 30 along the axis B.

The striker comprises a locking protrusion 41 configured to engage the through cavity in the locked state EV, said protrusion 41 having, in particular as illustrated in FIG. 10:
a first guide slope 41a, configured to engage with a first lateral edge of the through cavity Cav1 to push the latch relative to the striker in a first direction along the direction of the axis A,
a second guide slope 41b, diametrically opposite with respect to the longitudinal axis of the striker, configured to engage with a second lateral edge of the through cavity Cav1 to push the latch with respect to the striker in a first direction along the direction of the axis A.

It should be noted that said intermediate cavity Cav1 is arranged, along the axis B of the engagement portion 3, at a distance from the fork, separated by a median portion of the latch.

According to one embodiment, and in particular as illustrated in FIGS. 8 and 9, the system can comprise a reinforcement rib NR extending along the direction of the longitudinal axis of the striker between the base of the vertical wing of the T of the hooking member 30 and a base of said protrusion 41. The engagement portion 3 of the latch (in particular, its median portion between said fork and said through cavity Cav1) can comprise a groove RA extending the axis B, housing the reinforcement rib NR in the locked state EV.

According to one embodiment, said at least one cavity Cav 1, Cav2 can comprise an end cavity with a V-shaped profile, opening at the proximal end, on the side of the axis A opposite the distal end ED of the engagement portion 3 of the latch.

The striker then comprises a triangular protrusion 42 comprising two V-shaped stop surfaces, which consist of a first stop surface 42a and a second stop surface 42b, inclined relative to one another on either side of the longitudinal axis of the striker and configured to cooperate respectively with the two corresponding walls of the V-shaped cavity Cav 2.

According to one embodiment, said system can comprise:
said through cavity arranged intermediate on the engagement portion, between the axis A and said at least one hooking portion 30 forming a first cavity Cav1, configured to engage with the protrusion 41, which is a first protrusion
said end cavity opening at the proximal end, on the side of the axis A opposite to the distal end ED of the engagement portion 3d of the latch forming a second cavity Cav2 configured to engage with the triangular protrusion 42, which is a second protrusion.

In the locked state EV, the latch P is locked with respect to the striker, by the first protrusion 41 housed in the first cavity Cav1 and by the second protrusion 42 housed in the second cavity Cav2, on either side of the axis A.

According to an advantageous embodiment, the first protrusion 41 and the second protrusion 42 are configured, during a pivoting to locking RV of the latch about the axis A, from the unlocked state EDV to the locked state EV, to ensure:
a first centring of the latch P with respect to the striker G along the direction of the axis A by working the first guide slope 41a on the first lateral edge of the through cavity Cav1 and/or the second guide slope 42b on the second lateral edge of the through cavity Cv2, and then successively
a second centring of the latch P with respect to the striker G along the direction of the axis A by working one of the first of the two V-shaped walls of the triangular protrusion 42 on one of the two V-shaped walls of the second cavity V2 and/or working a second of the two V-shaped walls of the triangular protrusion on the other of the two V-shaped walls of the second cavity V2.

According to the first embodiment, said proximal end EP of an engagement portion can include a cylindrical portion coaxial to the axis A. In the locked state EV, the striker then comprises a semi-cylindrical cavity, partially receiving the cylindrical portion, in particular the semi-cylindrical cavity arranged between the first protrusion 41 and the second protrusion 42, and as visible in FIG. 2. If this feature improves locking, the semi-cylindrical cavity may be an inconvenience during locking operations.

Thus, and when the operator closes the door, there is then a possibility that the distal end ED of the latch comes to engage, not against the guide surface SG, but to be housed in the cylindrical cavity. In such a case, the distal end of the latch is trapped in the cylindrical cavity, preventing rotation to locking RV of the latch, if the operator never moves the door back beforehand. The second embodiment in FIGS. 13 to 17 improves this situation.

According to this second embodiment, the ramp of the guide surface, increasing along the direction of the hooking member with respect to the fastening surface towards said at least protrusion, extends up to a top formed by a plate PLT. This plate is substantially parallel to the fastening surface 43 of said striker, a plate on which the distal end ED of the engagement part 3 abuts in said unlocked state EDV. It is understood as substantially parallel the fact that the plate is parallel to the fastening surface 43, or even very slightly inclined by an angle of less than 5°, such as 2°, and preferably in the same direction as the slope of the ramp.

Thus, and when the operator closes the loss, the distal end ED of the latch comes to engage, not either from the guide surface SG, or on the plate PLT. When the distal end engages with the plate PLT. In the latter case, a rotation to locking RV causes the sliding of the distal end, on the plate, and then descending the ramp to ensure engagement of the hooking member and up to the unlocked state, and without having to move back the door.

In general, the plate PLT can extend along the length of the striker between the first protrusion 41 and the second protrusion 42.

Said proximal end EP of said engagement portion 3 of the latch P can comprise a tapered portion with a thickness Ep2, less than the thickness Ep1 of a median portion of the engagement portion 3 between said distal end EP and said proximal end ED. The tapered portion configured to come opposite the plate PLT in the locked state EV, and as illustrated in FIG. 15. In particular, it should be noted that the tapered portion can comprise at least one flat that can be configured to abut against the plate PLT try in the locked state EV.

It should also be noted that, on the side of the fastening surface 43, the striker can be recessed, in a median position in two end portions, and in order to limit the amount of material used. Such a recess is visible by way of example on the second embodiment.

The present disclosure also relates to an opening and closing device 1 for a truck or semitrailer door, comprising at least one door PT pivotally hinged to a post M of a frame DM of a body of the truck or semitrailer. The device 1 comprises a control bar B pivotably hinged by bearings PL on said door, as well as at least one latch and keeper system according to the present disclosure, the latch P of which is attached to an end of the control bar BC, and the striker G attached by the fastening surface 43 to a cross member, upper or lower, of the door frame.

The latch and striker system is configured during a pivoting to unlocking RD of the latch about the axis A from the locked state to said unlocked state EDV to cause, successively, during the pivoting to unlocking RD of the latch about the axis A:
a disengagement between said at least one hooking portion 30 of the distal end of the latch and the hooking member 40 of the striker,
a making contact at the distal end ED of the latch and at least one guide surface SG of the striker extending over the body 4 of the striker, lengthwise over the striker body, from a base of the hooking member 40, and in the direction of said at least one locking protrusion 41, 42,
a pushing of the latch P onto the striker by the distal end of the latch sliding on the guide surface, and until the axis B of the engagement portion 3 of the latch is substantially perpendicular to the fastening surface 43 in an extraction position.

The extraction distance DE separating the axis A and the fastening surface 43 of the striker in said extraction position is greater than or equal to 75 mm, preferably greater than 80 mm, and for example between 80 mm and 110 mm, such as 87 mm or 97 mm, and preferably according to a travel of the axis A, and preferably according to a movement of the axis A by a travel projected along a direction perpendicular to the fastening surface 43 greater than 50 mm preferably greater than 55 mm, such as 60.5 mm, between the locked state EV and the unlocked state EDV, or even greater than 65 mm such as 70.5 mm.

The present disclosure further relates to the use of the opening and closing device according to the present disclosure for a body door of a refrigerated semitrailer or refrigerated truck comprising seals between the frame and the door, said latch extraction position configured to ensure a movement of the door upon opening at the axis A, allowing the disengagement of the seals in whole at least partially.

### LIST OF REFERENCE SIGNS

1: Opening and closing device,
P. Latch,
2. Male part,
A. Axis of male part
3. Engagement part,
B. Axis of the engagement part
EP. Proximal end,
ED. Distal end,
30. Hooking portion
30a, 30b. First and second hooking portion
Cav 1, Cav 2. Cavities (locking)
G. striker,
4 Body (striker)
40. hooking member (intended to be hooked by the hooking part of the latch)
41, 42 Locking protrusions (intended to penetrate the latch locking cavities,
41a, 41b first guide slope and second guide slope
43. Fastening surface,
BC. Control bar,
PL. Bearings
PT. Door,
DM. Frame,
M. Post
TS. Upper cross member,
TI. Lower cross member,
RD. Pivoting to unlocking (FIG. 4),
DE. Extraction distance (separating the axis A from the fastening surface 43),
DS. Distance from the top of the ramp to the fastening surface 43
DEP. Distance separating the distal end of the latch from axis A,
BR1, BR2. First branch and second branch (fork),
PGC. Converging guide walls,
PGR. Straight guide walls
EV. Locked state,
EDV. Unlocked state.

1. A latch and striker system for an opening and closing device of a body door of a truck or semitrailer, the system comprising a latch (P) and a striker (G), said door (PT) being configured to move from an open position to a closed position, by hinging of the door (PT), typically in to a vertical pivoting on a post (M) of a frame, the striker intended to be attached to the frame (DM) of the door, typically to an upper cross member (TS) or to a lower cross member (TI) of the door frame, and the latch (P) intended to be mounted secured to one end of a control bar (BC) of the opening and closing device, said control bar being tubular, pivotably mounted on the door, via bearings (PL), said opening and closing device configured to switch from a locked state (EV) for which the latch (P) comes to the engagement and locking position in the striker (G) to an unlocked state (EDV) by pivoting the control rod, which allows disengagement between the latch and the striker
the latch (P) comprising:
a male part configured to be nested in a recess of the control bar (BC), at a mouth of the control bar, said male part extending along an axis A, intended to be coaxial to the control bar,
an engagement part configured to engage and lock in position in said striker extending lengthwise along an axis B, transverse to the axis A, from a proximal end (EP) secured to the male part at which at least one locking cavity (Cav 1, Cav 2) is provided and up to a distal end (ED) comprising a fork and at least one hooking portion having a first hooking portion and a second hooking portion, spaced apart from one another along the axis A, respectively arranged at the ends of a first branch and of a second branch of the fork,
the striker (G) comprising a body extending in length including, on one side, a flat fastening surface, configured to bear on the door frame, and including on a second side in relief, offset over the length of the striker:
a hooking member, configured to be hooked by the distal end (ED) of the latch engagement portion, said hooking member being a T-shaped part comprising a vertical wing of the T-shaped part, extending along a direction perpendicular to a plane of the fastening surface and a horizontal wing of the T-shaped part, said vertical wing protruding from the body the striker and said horizontal wing oriented along a direction transverse to the longitudinal axis of the striker,
at least one locking protrusion configured to penetrate said at least one locking cavity (Cav 1, Cav2),
said latch being configured during a pivoting to locking about the axis A, from the unlocked state (EDV) to successively ensure engagement of the hooking member by said at least one hooking portion, and then a traction on the striker up to said at least one locking protrusion engages in said at least one cavity (Cav1, Cav2) in said locked state (EV), during which, during the passage from the unlocked state (EDV) to the locked state (EV), the first leg (BR1) and the second leg (BR2) of the fork are configured to come on either side of the vertical wing of the T-shaped part, the first hooking portion and the second hooking portion configured to hook an inner edge of the horizontal wing of the T-shaped part, on either side of the vertical wing of the T-shaped part,
and wherein, in the locked state (EV), the engagement portion of the latch (P) extends along the axis B, substantially parallel to the longitudinal axis of the striker (G), said at least one hooking portion of the latch hooked onto said hooking member in order to ensure locking of the latch with respect to the striker along the axis B, said at least one locking protrusion engaging in said at least one cavity of the latch (Cav1, Cav2) so as to ensure that the latch locks in relation to the striker along the axis A of the latch
and wherein the latch and striker system is configured during a pivoting to unlocking (RD) of the latch about the axis A from the locked state (EV) to said unlocked state (EDV) to successively cause, during the pivoting to unlocking (RD) of the latch about the axis A:
a disengagement between said at least one hooking portion of the distal end of the latch and the hooking member of the striker,
a making contact at the distal end (ED) of the latch and at least one guide surface (SG) of the striker extending on the body of the striker, lengthwise on the striker body, from a base of the hooking member, and in the direction of said at least one locking protrusion,
a pushing of the latch (P) onto the striker by the distal end (ED) of the latch sliding on the guide surface (SG), and until the axis B of the engagement portion of the latch is substantially perpendicular to the fastening surface in a latch extraction position.
and wherein the extraction distance (DE) separating the axis A and the fastening surface of the striker in said extraction position, at the end of pushing, is greater than or equal to 75 mm, preferably greater than 80 mm, for example between 80 mm and 110 mm, such as 87 mm or 97 mm.

2. The latch and striker system according to claim 1, wherein, in the locked state (EV) for which the latch (P) is engaged in the striker (G), the locking distance separating the axis A and the fastening surface is between 20 mm and 32 mm, such as 26.5 mm.

3. The latch and striker system according to claim 1, configured, when the control bar is pivoted to unlocking (RD), from the locked state (EV) to the unlocked state (EDV) in the latch extraction position, to move the axis A of the latch away from the fastening surface by a stroke projected along a direction perpendicular to the fastening surface greater than 50 mm, preferably greater than 55 mm, such as 60.5 mm, or even greater than 65 mm or 70.5 mm.

4. The latch and striker system according to claim 1, wherein the guide surface (GD) along which the distal end (EP) of the engagement portion of the latch slides during the pivoting to unlocking (RD) forms a ramp with respect to the fastening surface, increasing along the direction of the hooking member towards said at least protrusion, and wherein the distal end (ED) is configured to travel up along the ramp when pivoting to unlocking (RD).

5. The latch and striker system according to claim 4, wherein a top of the ramp of the guide surface (SG) at which the distal end is able to press at said extraction position is at a distance (DS) from the fastening surface between 15 mm and 23 mm, such as 19 mm, and wherein the height of the ramp along the direction perpendicular to the fastening surface is between 6 mm and 15 mm.

6. The latch and striker system according to claim 5, wherein the top of the ramp forms a male protrusion received in a female portion of the latch in the locked state (EV).

7. The latch and striker system according to claim 1, wherein the distance (DEP) separating the axis A from the distal end (ED) of the engagement portion of the latch is between 54.5 mm and 90 mm, such as 68 mm or 78 mm.

8. The latch and striker system according to claim 6, wherein the guide surface (SG) comprises a first guide surface, and a second guide surface extending parallel along the length of the striker body, on either side of said vertical wing of the T-shaped part, and wherein
the first guide surface is configured to cooperate slidingly with the end of the first leg (BR1) of the fork, and
the second guide surface is configured to cooperate slidingly with the terminal end of the second branch (BR2) of the fork.

9. The latch and striker system according to claim 1, wherein said at least one cavity (Cav 1, Cav 2) comprises a through cavity (Cav 1) with a closed contour, arranged intermediate on the engagement portion, between the axis A and said at least one hooking portion, and wherein the striker comprises a protrusion configured to engage the through cavity in the locked state (EV),
said protrusion (41) having:
a first guide slope, configured to engage with a first lateral edge of the through cavity (Cav1) to push the latch relative to the striker in a first direction along the direction of the axis A,
a second guide slope, diametrically opposite with respect to the longitudinal axis of the striker, configured to engage with a second lateral edge of the through cavity (Cav1) to push the latch with respect to the striker in a first direction along the direction of the axis A.

10. A system according to claim 8, comprising a reinforcement rib (NR) extending along the direction of the longitudinal axis of the striker between the base of the vertical wing of the T and a base of said protrusion, and wherein the engagement portion of the latch comprises a groove (RA), extending along the axis B of the engagement portion 3, housing the reinforcement rib (NR) in the locked state (EV).

11. The latch and striker system according to claim 1, wherein said at least one cavity (Cav 1, Cav2) comprises an end cavity with a V-shaped profile, opening at the proximal end, on the side of the axis A opposite the distal end (ED) of the engagement portion of the latch, and wherein the striker comprises a triangular protrusion comprising two V-shaped stop surfaces consisting of a first stop surface and a second stop surface configured to cooperate with the two walls of the V-shaped cavity (Cav 2).

12. The latch and striker system according to claim 9, comprising:
said through cavity arranged intermediate on the engagement portion, between the axis A and said at least one hooking portion forming a first cavity (Cav1), configured to engage with the protrusion, which is a first protrusion
said end cavity opening at the proximal end, on the side of the axis A opposite the distal end (ED) of the engagement portion of the latch forming a second cavity (Cav2) configured to engage with the triangular protrusion, which is a second protrusion and wherein, in the locked state (EV), the latch (P) is locked with respect to the striker, by the first protrusion in the first cavity (Cav1) and by the second protrusion in the second cavity (Cav2), on either side of the axis A.

13. The latch and striker system according to claim 12, wherein the first protrusion and the second protrusion are configured, during a pivoting to locking (RV) of the latch about the axis A, from the unlocked state (EDV) to the locked state (EV), to ensure:
a first centring of the latch (P) with respect to the striker (G) along the direction of the axis A by working the first guide slope on the first lateral edge of the through cavity (Cav1) and/or the second guide slope on the second lateral edge of the through cavity (Cv2), and then successively
a second centring of the latch (P) with respect to the striker (G) along the direction of the axis A by working a first of the two V-shaped walls of the triangular protrusion on one of the two V-shaped walls of the second cavity (V2) and/or working a second of the two V-shaped walls of the triangular protrusion on the other of the two V-shaped walls of the second cavity (V2).

14. The latch and striker system according to claim 12, wherein said proximal end (EP) of engagement portion includes a cylindrical portion coaxial to the axis A, and wherein, in the locked state (EV), the striker comprises a semi-cylindrical cavity, partially receiving the cylindrical portion, in particular the semi-cylindrical cavity arranged between the first protrusion and the second protrusion.

15. The latch and striker system according to claim 4, wherein the ramp of the guide surface (GD), increasing along the direction of the hooking member, relative to the fastening surface, towards said at least protruding surface extends up to a top formed by a plate (PLT), substantially parallel to the fastening surface of said striker, plate against which the distal end (ED) of the engagement part abuts in said unlocked state (EDV).

16. The latch and striker system according to claim 12, wherein a plate (PLT) extends along the length of the striker between a first protrusion and a second protrusion.

17. The latch and striker system according to claim 16, wherein said proximal end (EP) of said engagement portion of the latch (P) comprises a tapered portion with a thickness Ep2, less than the thickness Ep1 of a median portion of the engagement portion between said distal end (EP) and said proximal end (ED), the tapered portion configured to come opposite the plate (PLT) in the locked state (EV).

18. The latch and striker system according to claim 1, wherein the latch and the striker are forged metal parts.

19. The latch and striker system according to claim 1, wherein:
the latch includes a plane of symmetry passing through the axis A of the male part, and through the axis B, longitudinal to the engagement part,
the striker includes a plane of symmetry passing through the longitudinal axis of said striker.

20. An opening and closing device for a truck or semitrailer door, comprising at least one door (PT) pivotably hinged to a post (M) of a frame (DM), the device comprising a control bar (BC) pivotably hinged by bearings (PL) to the door, as well as at least one latch and keeper system according to claim 1, the latch (P) of which is fastened to an end of the control bar (BC), and the striker (G) fastened by the fastening surface to a cross member, top or bottom, of the door frame
and wherein the latch and striker system is configured during a pivoting to unlocking (RD) of the latch about the axis A from the locked state (EV) to said unlocked state (EDV) to successively cause, during the pivoting to unlocking (RD) of the latch about the axis A:
a disengagement between said at least one hooking portion of the distal end of the latch and the hooking member of the striker,
a making of contact between the distal end (ED) of the latch and at least one guide surface (SG) of the striker extending on the body of the striker, lengthwise on the striker body, from a base of the hooking member, and in the direction of said at least one locking protrusion,
a pushing of the latch (P) on the striker by the distal end (ED) of the latch sliding on the guide surface (SG), and until the axis B of the engagement portion of the latch is substantially perpendicular to the fastening surface in an extraction position, and wherein the extraction distance (DE) separating the axis A and the fastening surface of the striker in said extraction position, at the end of the pushing, is greater than or equal to 75 mm, preferably greater than 80 mm, for example between 80 mm and 110 mm, such as 87 mm or 97 mm, and preferably according to a movement of the axis A by a travel projected along a direction perpendicular to the fastening surface greater than 50 mm, preferably greater than 55 mm, such as 60.5 mm, or even greater than 65 mm, such as 70.5 mm.
